(19) United States
(12) Patent Application Publication
(10) Pub. No.: US 2008/0084380 A1
(43) Pub. Date: Apr. 10, 2008

(54) Display Device

(76) Inventors: Yoshihiro Kotani, Chiba (JP); Yoshinori Aoki, Mobara (JP); Mitsuru Goto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/865,747

(22) Filed: Oct. 2, 2007

(30) Foreign Application Priority Data
Oct. 6, 2006 (JP) 2006-274548

(51) Int. Cl. G09G 3/12

(52) U.S. Cl. 345/98

(57) ABSTRACT

A display device includes a display panel and a driving circuit for driving each pixel of the display panel, in which a VCCIO voltage and a VCC voltage equal to or larger than the VCCIO voltage (VCCIO≦VCC) is inputted to the driving circuit. The driving circuit has a first level conversion circuit for converting a signal voltage level from a VCCIO voltage level to a VCC voltage level, and a level sense circuit for detecting a state in which the VCCIO voltage is not inputted. When the state in which the VCCIO voltage is not inputted is detected in the level sense circuit, operation of the first level conversion circuit is stopped. The driving circuit has a Vdd control signal for controlling operation of a Vdd voltage generation circuit, and the level sense circuit is a NAND circuit having the VCC voltage as a power supply voltage and having the VCCIO voltage and the Vdd control signal as inputs.

### CLAIM OF PRIORITY

The present application claims priority from Japanese Application JP 2006-274548 filed on Oct. 6, 2006, the content of which is hereby incorporated by reference into this application.

### BACKGROUND OF THE INVENTION

(1) Field of the Invention

The present invention relates to a display device, and more specifically to an effective technology for turning on a power of the display device.

(2) Description of the Related Arts

A liquid crystal display module of a TFT (Thin Film Transistor) type having a compact liquid crystal display panel has been widely used as a display part of a cellular phone, a digital camera, or the like.

This compact liquid crystal display module has, as external input voltages inputted from outside, two voltages: an interface voltage (VCCIO) and an internal logic/analog voltage (VCC). Moreover, in a power supply circuit inside the liquid crystal display module, as a power supply voltage for a logic circuit, a Vdd voltage is generated from the VCC voltage.

On the other hand, to convert a signal voltage level from a VCCIO voltage level to a VCC voltage level, for example, a level conversion circuit as shown in FIG. 10 is used.

The level conversion circuit shown in FIG. 10 has: between a VCC power supply voltage and GND ground voltages, a p-channel MOS transistor (hereinafter simply referred to as PMOS) (PM3), PMOS (PM1), and an n-channel MOS transistor (hereinafter simply referred to as NMOS) (NM1) connected in series, and a PMOS (PM4), a PMOS (PM2), and an NMOS (NM2) connected in series.

Then, to the gate of the PMOS (PM1) and the gate of the NMOS (NM1), a signal of the VCCIO voltage level is inputted; to the gate of the PMOS (PM2) and the gate of the NMOS (NM2), an inversion signal of a signal of the VCCIO voltage level (signal of a bar VCCIO voltage level) is inputted.

The gate of the PMOS (PM4) and the drain of the NMOS (NM1) are connected together, and the gate of the PMOS (PM3) and the drain of the NMOS (NM2) are connected together, and the drain of the NMOS (NM2) serves as an output terminal (OUT).

In the liquid crystal display module described above, to return on a power, a VCC voltage needs to be inputted after a VCCIO voltage is inputted for the following reasons.

(1) If the VCC voltage is inputted earlier than the VCCIO voltage, the logic is not fixed, thus resulting in a possibility that a through current flows to the level conversion circuit shown in FIG. 10 or a possibility that a very great amount of current flows thereto due to an unstable inner state.

### (2) Moreover, when only the VCCIO voltage is inputted, a Vdd voltage is generated on the more inner side than the VCC voltage; therefore, Vdd=0V, thus resulting in a possibility of false operation.

As described above, the aforementioned liquid crystal display module suffers from the limitation that the VCC voltage needs to be inputted after the VCCIO voltage is inputted. In recent years, there has been a demand for achieving freely inputting the VCCIO voltage and the VCC voltage at arbitrary timing without being restricted by this limitation.

To address the problem described above, the present invention has been made, and it is an object of the invention to provide a technology that permits inputting a VCCIO voltage and a VCC voltage freely at arbitrary timing in a display device.

The above-mentioned and other objects and new characteristics of the invention will be more clarified by the description in this specification and also by the accompanying drawings.

### SUMMARY OF THE INVENTION

The outline of those representing the invention disclosed in this application will be briefly described as follows.

(1) A display device includes a display panel and a driving circuit for driving each pixel of the display panel, in which a VCCIO voltage and a VCC voltage equal to or larger than the VCCIO voltage (VCCIO≦VCC) are inputted to the driving circuit. The driving current has a first level conversion circuit for converting a signal voltage level from a VCCIO voltage level to a VCC voltage level, and a level sense circuit for detecting a state in which the VCCIO voltage is not inputted. When the state in which the VCCIO voltage is not inputted is detected in the level sense circuit, operation of the first level conversion circuit is stopped.
(2) In (1), the driving circuit has: a Vdd voltage generation circuit for generating from the VCC voltage a Vdd voltage having a lower potential than the VCC voltage (Vdd<VCC); and a second level conversion circuit for converting a signal voltage level from the Vdd voltage level to the VCC voltage level, and when the state in which the VCCIO voltage is not inputted is detected in the level sense circuit, operation of the second level conversion circuit is stopped.
(3) In (2), the driving circuit has a Vdd control signal for controlling operation of the Vdd voltage generation circuit, and the level sense circuit is a NAND circuit having the VCC voltage as a power supply voltage, and the VCCIO voltage and the Vdd control signal as inputs.
(4) A display device includes: a display panel; and a driving circuit for driving each pixel of the display panel, in which a VCCIO voltage and a VCC voltage equal to or larger than the VCCIO voltage (VCCIO≦VCC) are inputted to the driving circuit. The driving circuit has: a Vdd voltage generation circuit for generating from the VCC voltage a Vdd voltage having a lower potential than the VCCIO voltage (Vdd<VCCIO); a third level conversion circuit for converting a signal voltage level from a Vdd voltage level to a VCCIO voltage level; and a level sense circuit for detecting a state in which the VCC voltage is not inputted. When the state in which the VCC voltage is not inputted is detected in the level sense circuit, operation of the third level conversion circuit is stopped.
(5) In (4), the driving circuit has a Vdd control signal for controlling operation of the Vdd voltage generation circuit, and the level sense circuit is a NAND circuit having the VCCIO voltage as a power supply voltage, and the VCC voltage and the Vdd control signal as inputs.

### (6) In (3) or (5), where a ratio between a gate width and gate length of an MOS transistor in the level sense circuit is (W/L), (W/L) of a p-channel MOS transistor is 1/100 and (W/L) of an n-channel MOS transistor is 5/10.

### (7) In any of (1) through (6), the display device is a liquid crystal display device, and the display panel is a liquid crystal display panel.

The advantages provided by those representing the present invention disclosed in this application will be briefly described as follows.

According to the invention, a VCCIO voltage and a VCC voltage can be freely inputted at arbitrary timing in a display device.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing schematic configuration of a liquid crystal display module according to an embodiment of the present invention;

FIG. 2 is a circuit diagram showing one example of a level sense circuit for detecting a state in which a VCCIO voltage is not inputted from outside in the embodiment of the present invention;

FIG. 3 is a diagram showing a table of truth-values for the level sense circuit shown in FIG. 2;

FIG. 4 is a diagram showing relationship in level shift among a VCC voltage, a VCCIO voltage, and a Vdd voltage in the embodiment of the present invention;

FIG. 5 is a circuit diagram showing one example of a level conversion circuit according to the embodiment of the present invention;

FIG. 6 is a circuit diagram showing another example of the level conversion circuit according to the embodiment of the present invention;

FIG. 7 is a circuit diagram showing one example of a level sense circuit for detecting a state in which a VCC voltage is not inputted from outside in the embodiment of the present invention;

FIG. 8 is a diagram showing a table of truth-values for the level sense circuit shown in FIG. 7;

FIG. 9 is a circuit diagram showing still another example of the level conversion circuit according to the embodiment of the present invention; and

FIG. 10 is a circuit diagram showing a conventional level conversion circuit.

### DETAILED DESCRIPTION OF THE PREFERRED EMBODIMENTS

The embodiment of the present invention will be described in detail with reference to the accompanying drawings.

In all the figures for explaining the embodiment, those having the same function are provided with the same numerals symbols and thus their overlapping description will be omitted.

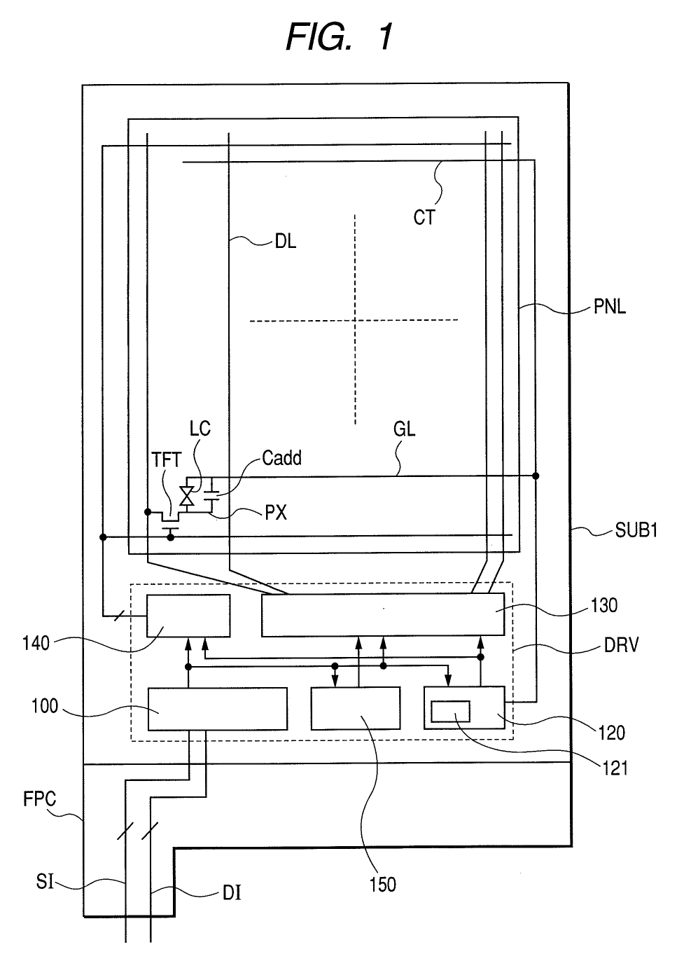

FIG. 1 is a block diagram showing schematic configuration of a liquid crystal display module according to the embodiment of the invention. In this figure, numeral 100 denotes a controller circuit, numeral 120 denotes a power supply circuit, numeral 121 denotes a Vdd generation circuit, numeral 130 denotes a source driver, numeral 140 denotes a gate driver, numeral 150 denotes a memory circuit, symbol PNL denotes a liquid crystal display panel, symbol DL denotes a video line (source line or drain line), symbol GL denotes a scan line (or gate line), symbol TFT denotes a thin-film transistor, symbol PX denotes a pixel electrode, symbol CT denotes an opposite electrode (also referred to as a common electrode), symbol LC denotes a liquid crystal capacitance, symbol Cadd denotes a storage capacitance, symbol SUB 1 denotes a first glass substrate, symbol DRV denotes a driving circuit, and symbol FPC denotes a flexible wiring board.

In the liquid crystal display panel (PNL), a plurality of scan lines (GL) are provided in parallel, and a plurality of video lines (DL) are provided in parallel. A sub pixel is provided in correspondence with a portion where the scan line (GL) and the video line (DL) intersect.

A plurality of sub pixels are arranged in a matrix form, each being provided with the pixel electrode (PX) and the thin-film transistor (TFT). In FIG. 1, the number of sub pixels included in the liquid crystal display panel (PNL) is 240×320×3.

The opposite electrode (CT) is so provided as to oppose each pixel electrode (PX). Thus, at every portion between the pixel electrode (PX) and the opposite electrode (CT), the liquid crystal capacitance (LC) and the storage capacitance (Cadd) are formed.

The liquid crystal display panel (PNL) is formed in the following manner. The first glass substrate (SUB1) where the pixel electrodes (PX), the thin-film transistors (TFT), and the like are provided and a second glass substrate (not shown) formed of a color filter or the like are superimposed on each other with a predetermined gap therebetween. Then these two substrates are attached together with a seal material provided in a frame form near the peripheral edge between the two glass substrates. Also, a liquid crystal is filled inside the seal material between the two substrates through a liquid crystal filling port provided at part of the seal material. Further a deflection plate is attached to the outer side of the two glass substrates.

The invention does not relate to inner structure of the liquid crystal display panel, and thus detailed description of the inner structure of the liquid crystal display panel is omitted. Further, the invention is applicable to liquid crystal display panels with any structure. For example, for a longitudinal electric field type, the opposite electrodes (CT) are formed on the second glass substrate. For a lateral electric field type, the opposite electrodes (CT) are formed on the first glass substrate (SUB1).

In the liquid crystal display module shown in FIG. 1, on the first glass substrate (SUB1), a driving circuit (DRV) is mounted.

The driving circuit (DRV) has: the controller circuit 100; the source driver 130 for driving the video lines (DL) of the liquid crystal display panel (PNL); the gate driver 140 for driving the scan lines (GL) of the liquid crystal display panel (PNL); the power supply circuit 120 for generating a power supply voltage and the like required for displaying an image on the liquid crystal display panel (PNL); and the memory circuit 150.

In this embodiment, two voltages, an interface voltage as VCCIO and an inner logic/analog voltage as VCC, are inputted from outside, and a Vdd generation circuit 121 of the power supply circuit 120 generates a power supply voltage for a logic circuit as Vdd from the VCC voltage.

FIG. 1 shows a case where the driving circuit (DRV) is formed of one semiconductor chip. The driving circuit (DRV) may be directly formed on the first glass substrate (SUB1) by using, for example, a thin-film transistor using a low-temperature poly silicone for a semiconductor layer.

Similarly, the driving circuit (DRV) may be formed with a plurality of semiconductor chips by dividing some circuits of the driving circuit (DRV), and some circuits of the driving circuit (DRV) may be directly formed on the first glass substrate (SUB1) by using, for example, a thin-film transistor using a low-temperature poly silicone for a semiconductor layer.

Further, the driving circuit (DRV) or some circuits of the driving circuit (DRV), instead of being mounted on the first glass substrate (SUB1), may be formed on the flexible wiring board.

To the controller circuit 100, display data and a display control signal are inputted from a main body side micro controller unit (hereinafter referred to as MCU), a graphic controller, or the like.

In FIG. 1, SI refers to a system interface, a system to which various control signals and image data are inputted from the MCU and the like.

DI refers to a display data interface (RGB interface), a system (external data) to which image data formed by an external graphic controller and a data-downloading clock are continuously inputted.

This display data interface (DI), similarly to a drain driver used in a conventional personal computer, sequentially downloads image data in step with the downloading clock.

The controller circuit 100 transmits image data received from the system interface (SI) and the display data interface (DI) to the source driver 130 and the RAM 150, and controls display.

This embodiment is mainly characterized in that, when only one of the VCCIO voltage and the VCC voltage is inputted, the VCCIO voltage and the VCC voltage can be inputted freely at arbitrary timing by stopping operation of a predetermined level conversion circuit. Hereinafter, this point will be described.

First, a case (state 1) where only the VCC voltage is inputted from outside will be described. This case requires detection of a state in which the VCCIO voltage is not inputted from outside.

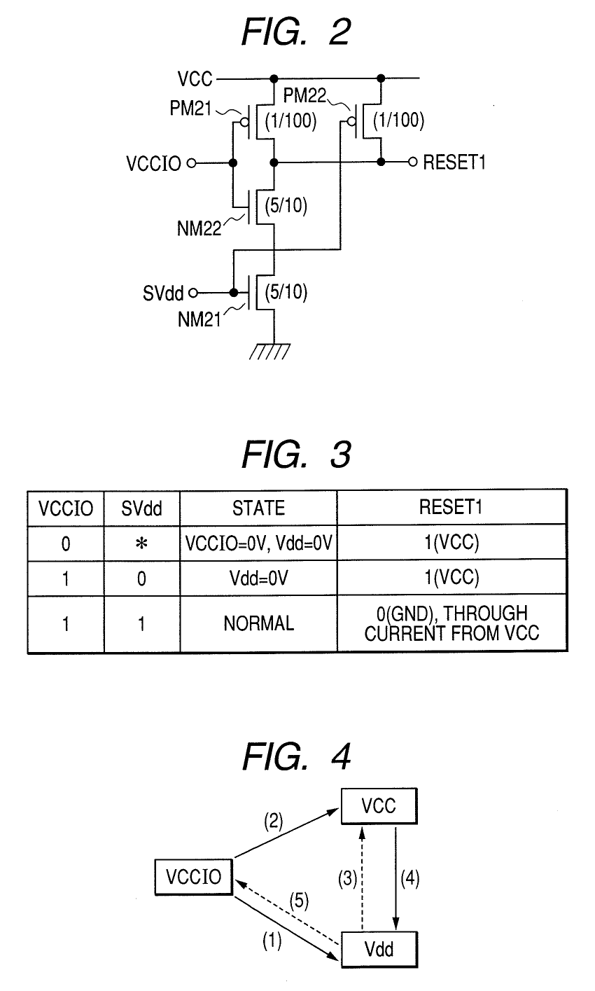

FIG. 2 is a circuit diagram showing one example of a level sense circuit for detecting a state in which the VCCIO voltage is not inputted from outside in this embodiment.

The level sense circuit shown in FIG. 2 has a PMOS (21) and a PMOS (22) connected in parallel between the VCC power supply voltage and an output terminal, has an NMOS (21) and an NMOS (22) serially connected between the output terminal and a ground voltage (GND), inputs the VCCIO voltage to the gate of the PMOS (21) and the gate of the NMOS (22), and inputs a Vdd control signal (SVdd) to the gate of the PMOS (22) and the gate of the NMOS (21). That is, the level sense circuit shown in FIG. 2 is a NAND circuit having the VCC as a power supply voltage and having the VCCIO voltage and the Vdd control signal (SVdd) as inputs.

The Vdd control signal (SVdd) is a signal for controlling operation of the Vdd generation circuit 121. The value “1” (High level) brings the Vdd generation circuit 121 into a normal operation state, while the value “0” (Low level) brings the Vdd generation circuit 121 into a stopped state.

FIG. 3 shows a table of truth-values for the level sense circuit shown in FIG. 2. As can be understood from the table of truth-values of FIG. 3, when VCCIO=0V or Vdd=0V, an output (RESET 1) is “1” (VCC voltage), and in other cases, the output (RESET 1) is “0”.

FIG. 4 is a diagram showing relationship in level shift among the VCC voltage, the VCCIO voltage, and the Vdd voltage.

At the state 1, for the case (5) in the diagram of level shift relationship of FIG. 4, VCCIO=0V; therefore, a through current does not flow to the level conversion circuit, thus resulting in no need for stopping operation of the level conversion circuit.

At the state 1, for the cases (1) and (4) in the diagram of level shift relationship of FIG. 4, VCCIO=0V; therefore, an output of the level sense circuit shown in FIG. 2 is “1” (High level). Then stopping the operation of the Vdd generation circuit 121 with this signal results in Vdd=0V, thus resulting in no need for stopping the operation of the level conversion circuit.

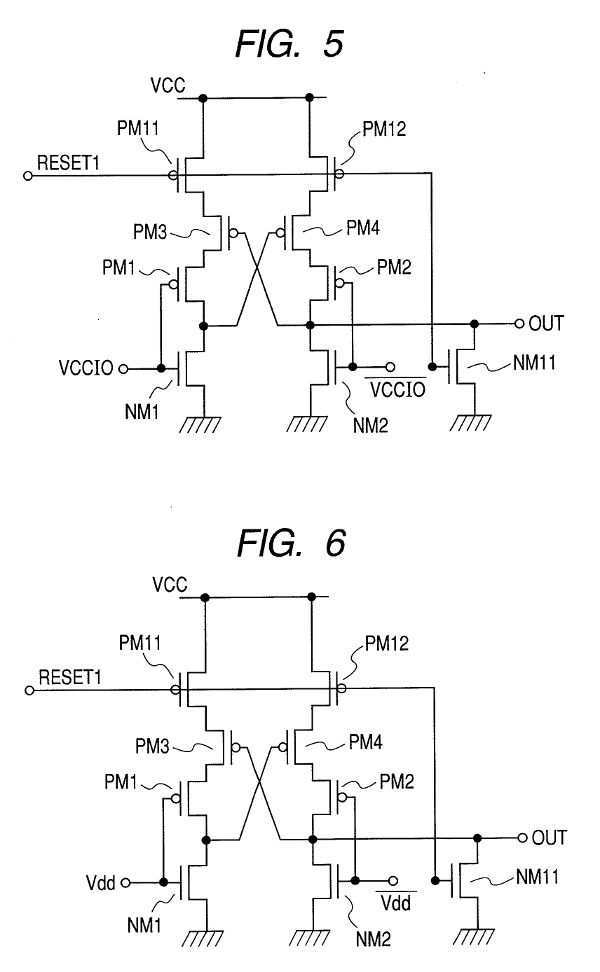

At the state 1, for the cases (2) and (3) in the diagram of level shift relationship of FIG. 4, for example, as shown in FIGS. 5 and 6, it is required to stop the operation of the level conversion circuit.

FIG. 5 is a circuit diagram showing one example of the level conversion circuit of this embodiment, i.e., a diagram showing the level conversion circuit that converts a signal voltage level from the VCCIO voltage level to the VCC voltage level. The level conversion circuit shown in FIG. 5 is different from the level conversion circuit shown in FIG. 10 in that it has a PMOS (PM11) connected between a PMOS (PM3) and a VCC power supply voltage, has a PMOS (PM12) connected between a PMOS (PM4) and the VCC power supply voltage, and further has an NMOS (NM11) connected between an output terminal (OUT) and a ground voltage (GND).

Then to the gates of the PMOS (PM11), the PMOS (PM12), and the NMOS (NM11), the output (RESET 1) of the level sense circuit shown in FIG. 2 is inputted.

In the level sense circuit shown in FIG. 2, the output (RESET 1) is “1” when VCCIO=0V or Vdd=0V.

Therefore, when VCCIO=0V or VDD=0V, the PMOS (PM11) and PMOS (PM12) of FIG. 5 is OFF and the NMOS (NM11) thereof is ON, which stops operation of the level conversion circuit, thus permitting an output of the level conversion circuit to be fixed at the ground voltage (GND).

FIG. 6 is a circuit diagram showing another example of the level conversion circuit of this embodiment, i.e., a diagram showing the level conversion circuit that converts a signal voltage level from the Vdd voltage level to the VCC voltage level.

Also in the level conversion circuit shown in FIG. 6, when VCCIO=0V or Vdd=0V, the PMOS (PM11) and PMOS (PM12) of FIG. 6 is OFF and an NMOS (NM11) thereof is ON, which stops operation of the level conversion circuit, thus permitting an output of the level conversion circuit to be fixed at a ground voltage (GND).

The level conversion circuit shown in FIG. 6 has the Vdd voltages replacing the VCCIO voltages of FIG. 5. The circuit configuration of the level conversion circuit shown in FIG. 6 is identical to that of FIG. 5, and thus description of the circuit configuration of the level conversion circuit shown in FIG. 6 will be omitted.

Next, description will be given, referring to a case (state 2) where only the VCCIO voltage is inputted from outside. This case requires detection of a state in which the VCC voltage is not inputted from outside.

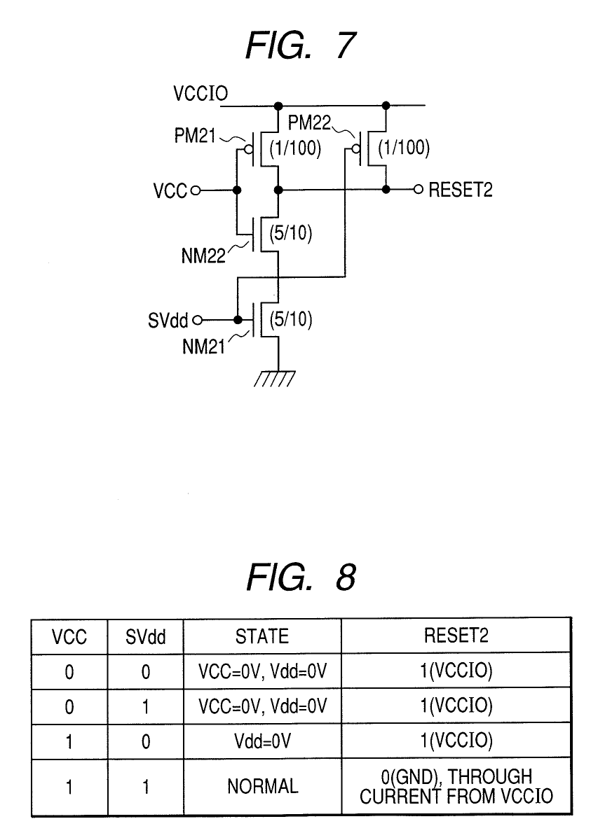

FIG. 7 is a circuit diagram showing one example of a level sense circuit for detecting a state in which the VCC voltage is not inputted from outside in this embodiment. The level sense circuit shown in FIG. 7 corresponds to the level sense circuit shown in FIG. 2, with the VCCIO voltage and the VCC voltage interchanged, that is, is a NAND circuit having the VCCIO as a power supply voltage and having the Vdd control signal (SVdd) and the VCC voltage as inputs.

The Vdd control signal (SVdd) is a signal for controlling the operation of the Vdd generation circuit 121, with the value “1” (High level) bringing the Vdd generation circuit 121 into a normal operation state and with the value “0” (Low level) bringing the Vdd generation circuit 121 to a stopped state.

FIG. 8 shows a table of truth-values for the level sense circuit shown in FIG. 7. As can be understood from the table of truth-values shown in FIG. 8, when VCC=0V or Vdd=0V, an output (RESET 2) is “1” (VCCIO voltage), and in other cases, the output (RESET 2) is “0”.

At the state 2, for the cases (2) and (3) in the diagram of level shift relationship of FIG. 4, VCC=0V; thus, a through current does not flow to the level conversion circuit, thus resulting in no need for stopping the operation of the level conversion circuit.

At the state 2, for the cases (1) and (4) in the diagram of level shift relationship FIG. 4, VCC=0V and thus Vdd=0V; therefore, a through current does not flow to the level conversion circuit, thus resulting in no need for stopping the operation of the level conversion circuit.

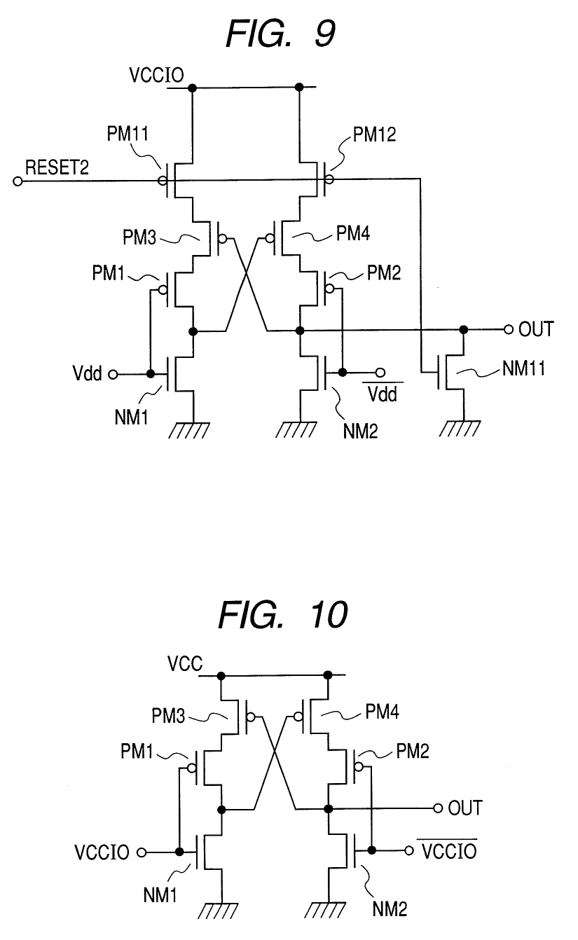

At the state 2, for the case (5) in the level shift relationship diagram of FIG. 4, for example, as shown in FIG. 9, it is required to stop the operation of the level conversion circuit.

FIG. 9 is a circuit diagram showing another example of the level conversion circuit of this embodiment, i.e., a diagram showing the level conversion circuit that converts a signal voltage level from the Vdd voltage level to the VCCIO voltage level.

Also in the level conversion circuit shown in FIG. 9, when VCC=0V or Vdd=0V, a PMOS (PM11) and PMOS (PM12) of FIG. 9 is OFF, and an NMOS (NM11) thereof is ON, which stops the operation of the level conversion circuit, thus permitting an output of the level conversion circuit to be fixed at a ground voltage (GND).

The level conversion circuit shown in FIG. 9 corresponds to that of FIG. 5, with the VCCIO voltage replacing the VCC voltage and with the Vdd voltages replacing the VCCIO voltages. The circuit configuration of the level conversion circuit shown in FIG. 9 is identical to that of FIG. 5, and thus description of the circuit configuration of the level conversion circuit shown in FIG. 9 will be omitted.

To reduce the power consumption, this embodiment may be applied under the assumption that Vdd=0V in some cases. However, if the Vdd control signal (SVdd) is not used in the level sense circuit shown in FIG. 2, when Vdd=0V, a through current flows to the level sense circuit, thus increasing the power consumption.

However, in the level sense circuit shown in FIG. 2, when the Vdd control signal (SVdd) is “0” (that is Vdd=0V), a through current does not flow to the level sense circuit, thus permitting reduction in the power consumption when Vdd=0V”.

Moreover, as can be understood from the table of truth-values of FIG. 3, at a normal state where the VCCIO is at “1” and the SVdd is at “1”, a through current flows to the level sense circuit shown in FIG. 2. In this embodiment, to reduce a through current at the normal state, the sizes of the MOS transistors are adjusted, more specifically, the ratio between the gate width and gate length of the MOS transistor of the level sense circuit shown in FIG. 2 is (W/L), (W/L) of the PMOS is 1/100 and (W/L) of the NMOS is 5/10.

Similarly, also in the level sense circuit shown in FIG. 7, to reduce a through current at the normal state, where the ratio between the gate width and gate length of the MOS transistor of the level sense circuit shown in FIG. 7 is (W/L), (W/L) of the PMOS is 1/100 and (W/L) of the NMOS is 5/10.

The above description refers to the embodiment in which the present invention is applied to a liquid crystal display module, but the invention is not limited thereto. Thus, it is needless to say that the invention is also applicable to other display devices that have a power supply circuit built therein.

The invention achieved by the inventors has been described in detail above, based on the aforementioned embodiment. However it is needless to say that the invention is not limited to the aforementioned embodiment, and thus various modifications can be made without departing from the spirit of the invention.

What is claimed is:

1. A display device comprising:
a display panel; and
a driving circuit for driving each pixel of the display panel to which a VCCIO voltage and a VCC voltage equal to or larger than the VCCIO voltage (VCCIO≦VCC) are inputted,
wherein the driving circuit has:
a first level conversion circuit for converting a signal voltage level from a VCCIO voltage level to a VCC voltage level; and
a level sense circuit for detecting a state in which the VCCIO voltage is not inputted, and
wherein, when the state in which the VCCIO voltage is not inputted is detected in the level sense circuit, operation of the first level conversion circuit is stopped.

2. The display device according to claim 1,
wherein the driving circuit has:
a Vdd voltage generation circuit for generating from the VCC voltage a Vdd voltage having a lower potential than the VCC voltage (Vdd<VCC); and
a second level conversion circuit for converting a signal voltage level from a Vdd voltage level to the VCC voltage level, and
wherein, when the state in which the VCCIO voltage is not inputted is detected in the level sense circuit, operation of the second level conversion circuit is stopped.

3. The display device according to claim 2,
wherein the driving circuit has a Vdd control signal for controlling operation of the Vdd voltage generation circuit, and
wherein the level sense circuit is a NAND circuit having the VCC voltage as a power supply voltage and having the VCCIO voltage and the Vdd control signal as inputs.

4. The display device according to claim 3,
wherein, where a ratio between a gate width and gate length of an MOS transistor in the level sense circuit is (W/L), (W/L) of a p-channel MOS transistor is 1/100 and (W/L) of an n-channel MOS transistor is 5/10.

5. The display device according to claim 1,
wherein the display device is a liquid crystal display device, and
wherein the display panel is a liquid crystal display panel.

6. A display device comprising:
a display panel; and
a driving circuit for driving each pixel of the display panel to which a VCCIO voltage and a VCC voltage equal to or larger than the VCCIO voltage (VCCIO≦VCC) are inputted,
wherein the driving current has:
a Vdd voltage generation circuit for generating from the VCC voltage a Vdd voltage having a lower potential than the VCCIO voltage (Vdd<VCCIO);
a third level conversion circuit for converting a signal voltage level from a Vdd voltage level to a VCCIO voltage level; and
a level sense circuit for detecting a state in which the VCC voltage is not inputted, and
wherein, when the state in the VCC voltage is not inputted is detected in the level sense circuit, operation of the third level conversion circuit is stopped.

7. The display device according to claim 6,
wherein the driving circuit has a Vdd control signal for controlling operation of the Vdd voltage generation circuit, and
wherein the level sense circuit is a NAND circuit having the VCCIO voltage as a power supply voltage and having the VCC voltage and the Vdd control signal as inputs.

8. The display device according to claim 7,
wherein, where a ratio between a gate width and gate length of an MOS transistor in the level sense circuit is (W/L), (W/L) of a p-channel MOS transistor is 1/100 and (W/L) of an n-channel MOS transistor is 5/10.

9. The display device according to claim 6,
wherein the display device is a liquid crystal display device, and
wherein the display panel is a liquid crystal display panel.
